(19) United States
(12) Patent Application Publication
(10) Pub. No.: US 2026/0164132 A1
(43) Pub. Date: Jun. 11, 2026

(54) ACTUATOR FOR CAMERA

(71) Applicant: JAHWA electronics Co., Ltd., Chungcheongbuk-do (KR)

(72) Inventors: HEE SEUNG KIM, Chungcheongbuk-do (KR); IN SOO KIM, Chungcheongbuk-do (KR); KI HOON JEON, Chungcheongbuk-do (KR)

(21) Appl. No.: 19/302,238

(22) Filed: Aug. 18, 2025

(30) Foreign Application Priority Data
Nov. 12, 2024 (KR) 10-2024-0160108

(51) Int. Cl. H04N 23/68; G03B 13/36; H04N 23/54

(52) U.S. Cl. CPC H04N 23/687; G03B 13/36; H04N 23/54; G03B 2205/0015; G03B 2205/0069

(57) ABSTRACT

An actuator for a camera according to an embodiment includes an OIS carrier configured to move in a direction perpendicular to an optical axis direction; an AF carrier configured to support the OIS carrier and move in the optical axis direction together with the OIS carrier; a housing configured to support the AF carrier; an OIS magnet installed on the OIS carrier; and an OIS coil installed in the housing to face the OIS magnet, wherein a height of the OIS magnet is at least twice a stroke, which is a moving distance of the AF carrier by AF driving.

### CROSS-REFERENCE TO RELATED APPLICATION AND CLAIM OF PRIORITY

This application claims the benefit under 35 USC § 119 of Korean Patent Application No. 10-2024-0160108 filed on Nov. 12, 2024, in the Korean Intellectual Property Office, the entire disclosure of which is incorporated herein by reference for all purposes.

### BACKGROUND

### 1. Technical Field

The present disclosure relates to an actuator for a camera, and more specifically, to an actuator for a camera, which further improves the position control of an OIS and driving precision.

### 2. Background Art

Advances in hardware technology for image processing and growing consumer need for making and taking photos and videos have driven implementation of such functions as autofocusing (AF) and optical image stabilization (OIS) in stand-alone cameras as well as camera modules mounted on mobile terminals including cellular phones and smartphones.

An autofocus (AF) function (or, an automatically focusing function) means a function of a focal length to a subject by linearly moving a carrier having a lens in an optical axis direction to generate a clear image at an image sensor (CMOS, CCD, etc.) located at the rear of the lens.

An optical image stabilization (OIS) function means a function of improving the sharpness of an image by adaptively moving the carrier having a lens in a direction to compensate for the shaking when the lens is shaken due to trembling.

One typical method for implementing the AF or OIS function is to install a magnet (a coil) on a mover (a carrier) and install a coil (a magnet) on a stator (a housing, or another type of carrier, or the like), and then generate an electromagnetic force between the coil and the magnet so that the mover moves in the optical axis direction or in a direction perpendicular to the optical axis.

In the case of a device or actuator with integrated AF and OIS functions, a structure in which an OIS carrier moves in a direction perpendicular to the optical axis (at least one of X-axis and Y-axis) with an AF carrier moving in the optical axis direction as a relative fixed body may be applied.

AF driving and OIS driving are performed independently, but when AF driving is performed by the above physical structure, the OIS carrier moves in the optical axis direction together with the AF carrier. Therefore, when AF and OIS are operated together, the OIS carrier moves not only in the X-axis and/or Y-axis direction, but also moves with a directionality including the optical axis direction (Z-axis direction) component.

The OIS hall sensor that detects the position of the OIS magnet (X-axis direction) and the OIS coil that provides a driving force to the OIS magnet are fixed in their positions. Thus, if the AF carrier moves up and down (based on the optical axis direction) due to the driving of the AF, the positional relationship between the OIS magnet and the OIS hall sensor and the positional relationship between the OIS magnet and the OIS coil change irregularly.

If the OIS magnet has a movement characteristic that includes a Z-axis direction component in this way, the precision of the position detection in each direction for implementing the OIS as well as the drive control based thereon is deteriorated.

Although a method to solve this problem by applying a compensation algorithm may be devised, this method requires a complex compensation algorithm that can reflect the irregular movement characteristics, which however increases the computational processing time and negatively affects the immediate responsiveness of the OIS.

### SUMMARY

The present disclosure is designed to solve the problems of the related art, and therefore the present disclosure is directed to providing an optical actuator (for a camera) that may further improve the precision of OIS driving by organically combining the physical arrangement structure of the OIS component (OIS magnet, etc.) with the moving distance (stroke) of the AF carrier.

Other technical goals and advantages of the present invention can be understood with reference to the description below, which will be made explicit by the accompanied examples. Furthermore, the technical goals and advantages of the present invention can be accomplished by the embodiments and their combinations recited in the attached claims. An actuator for a camera according to an embodiment of the present disclosure to accomplish the above object includes an OIS carrier configured to move in a direction perpendicular to an optical axis direction; an AF carrier configured to support the OIS carrier and move in the optical axis direction together with the OIS carrier; a housing configured to support the AF carrier; an OIS magnet installed on the OIS carrier; and an OIS coil installed in the housing to face the OIS magnet.

In this case, a height of the OIS magnet is at least twice a stroke, which is a moving distance of the AF carrier by AF driving.

In addition, a center position of the OIS magnet may be identical to or lower than a center position of the OIS coil, when the AF carrier is located at a center position of the stroke.

In addition, when the AF carrier is located at the center position of the stroke, a height deviation between the center position of the OIS magnet and the center position of the OIS coil may be 30% or less of the stroke.

Depending on an embodiment, the actuator according to an embodiment of the present disclosure may further include an OIS hall sensor installed in the housing to detect a position of the OIS magnet.

In this case, a center position of the OIS magnet may be identical to or lower than a center position of the OIS hall sensor, when the AF carrier is located at a center position of the stroke.

Furthermore, when the AF carrier is located at the center position of the stroke, a height deviation between the center position of the OIS magnet and the center position of the OIS hall sensor may be 30% or less of the stroke.

Depending on an embodiment, the actuator according to an embodiment of the present disclosure may further include an AF magnet installed on the AF carrier to face an AF coil installed in the housing; a yoke plate installed in the housing to generate an attractive force with the AF magnet; and a ball disposed between the housing and the AF carrier.

A height of the yoke plate may be greater than the sum of a height of the AF magnet and the stroke.

In a preferred embodiment of the present disclosure, the specifications, location, etc. of the OIS magnet are determined by organically reflecting the location, moving distance or range (stroke) of the AF carrier, etc., so that independent driving of the OIS may be effectively implemented even if the OIS carrier has irregular behavioral characteristics due to the movement of the AF carrier.

According to a preferred embodiment of the present disclosure, the driving performance of OIS may be implemented more effectively in a close-distance photographing environment where the precision of optical image stabilization is relatively greater.

### BRIEF DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a drawing showing an overall configuration of an actuator according to a preferred embodiment of the present disclosure,

FIG. 2 is a drawing showing a detailed configuration of an OIS carrier according to a preferred embodiment of the present disclosure,

FIG. 3 is a drawing showing a detailed configuration of an AF carrier according to a preferred embodiment of the present disclosure,

FIGS. 4 and 5 are drawings showing the structure of a first ball, a groove rail, and a guide rail,

FIG. 6 is a drawing showing the physical structure of a second carrier moving in each direction relative to a first carrier,

FIG. 7 is a drawing showing another embodiment of the OIS carrier,

FIG. 8 is a drawing showing the internal structure of an actuator according to an embodiment of the present disclosure,

FIG. 9 is a drawing showing a part A of FIG. 8 in detail,

FIG. 10 is a drawing showing the mutual positional relationship between an OIS magnet, an OIS coil, and an OIS hall sensor,

FIG. 11 is a drawing showing the configuration of an actuator according to another preferred embodiment of the present disclosure,

FIGS. 12 and 13 are drawings showing the ball, the first rail, and the second rail depicted in FIG. 11,

FIG. 14 is a partial cross-sectional view showing a ball and a yoke plate, and

FIG. 15 is a drawing showing the structural relationship between the yoke plate, the ball, the magnet, and the stroke.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

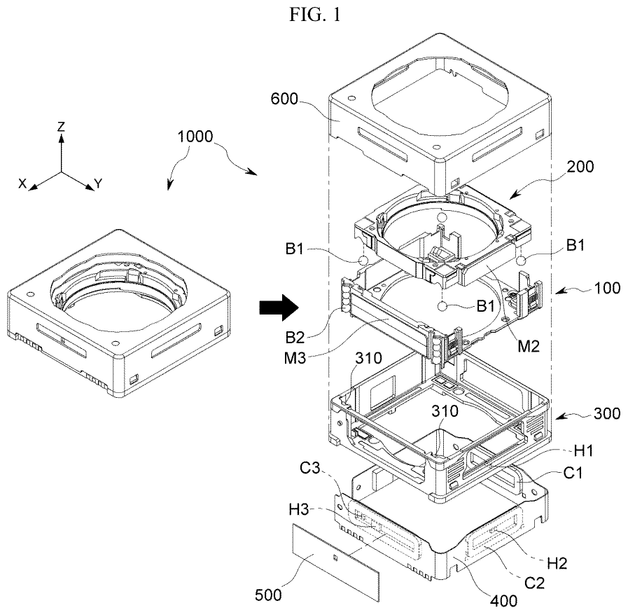

Hereinafter, referring to FIGS. 1 to 7, details on an embodiment of the present disclosure for implementing OIS, etc. will be described first, and specific details on the structural relationship of an OIS magnet, a stroke (AF stroke), an OIS coil, an OIS hall sensor, etc. will be described later.

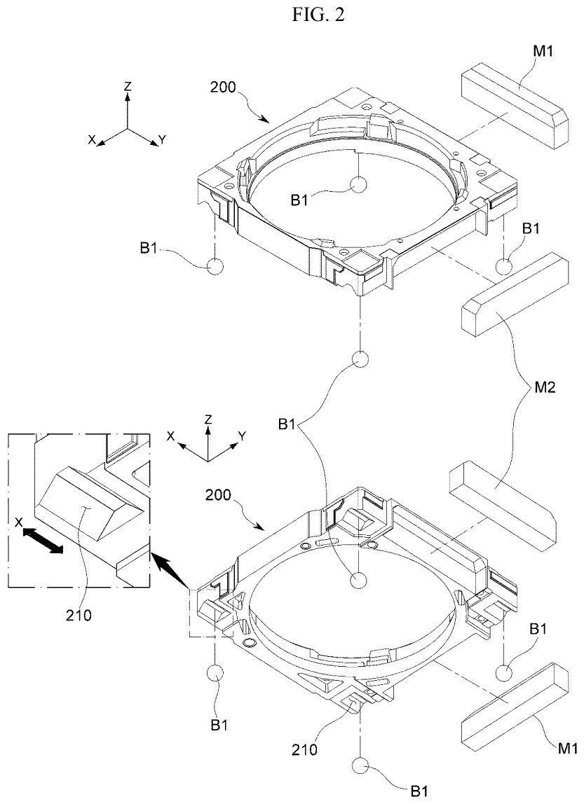

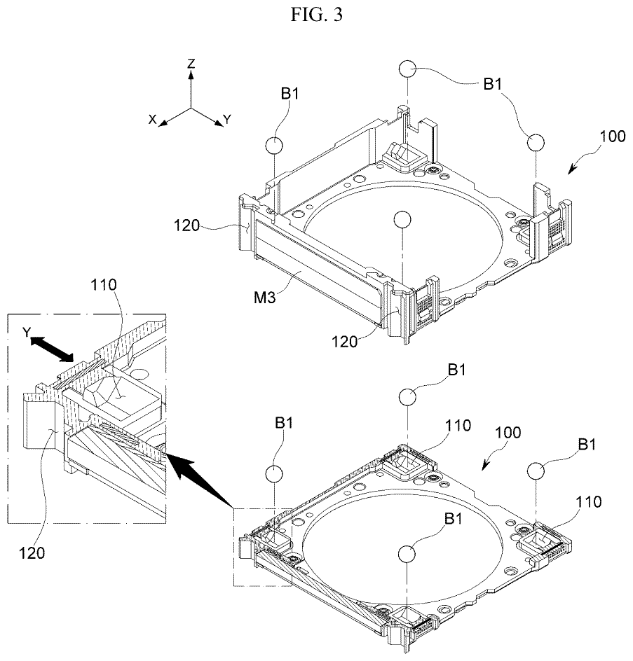

FIG. 1 is a drawing showing the configuration of an actuator 1000 for a camera (hereinafter referred to as “actuator”) according to a preferred embodiment of the present disclosure, and FIGS. 2 and 3 are drawings for explaining a first ball B1, a first rail R1, a second rail R2, etc. depicted in FIG. 1.

As shown in FIG. 1, the actuator 1000 of the present disclosure may be configured to include a first carrier (AF carrier) 100, a second carrier (OIS carrier) 200, a housing 300, a circuit board 400, a yoke plate 500, and a case 600.

The Z-axis direction shown in FIG. 1 is an optical axis direction in which light enters a lens or a lens assembly (not shown), and corresponds to a direction in which the first carrier 100 moves forward and backward when AF is driven. Also, the X-axis and Y-axis, which are perpendicular to the optical axis, correspond to directions in which the second carrier 200 moves when OIS is driven.

Hereinafter, in describing the embodiment of the present disclosure, one of two directions perpendicular to the optical axis is referred to as a first direction (X-axis direction) and the other as a second direction (Y-axis direction). However, this is only an example according to a relative viewpoint, and it is also possible that either the X-axis direction or the Y-axis direction is the first direction and the other direction is the second direction.

The housing 300 of the present disclosure corresponds to a basic frame structure that accommodates internal components of the actuator 1000 according to the present disclosure, and may be coupled with a case 600 that functions as a shield can depending on an embodiment.

The second carrier 200 is a moving body that moves in the first direction or/and the second direction with respect to the first carrier 100, and when a lens or an image sensor is mounted on the second carrier 200, OIS is implemented to eliminate external disturbance phenomena such as hand trembling by moving the lens or the image sensor according to the movement of the second carrier 200.

In this respect, the second carrier 200 corresponds to a moving body that moves relatively to the first carrier 100, and from a corresponding point of view, the first carrier 100 corresponds to a relative fixed body.

According to an embodiment, the first ball B1 may be disposed between the first carrier 100 and the second carrier 200 as shown in the drawings. In order to implement effective guiding for linearity, it is preferable that the first ball B1 is configured to be partially accommodated in at least one of the groove rail 110 formed on the first carrier 100 and the guide rail 210 formed on the second carrier 200.

If the first ball B1 is provided in this way, the second carrier 200 maintains an appropriate interval with the first carrier 100 by means of the first ball B1, and may linearly move more flexibly with minimized friction due to moving and rolling of the first ball B1, thereby further improving noise reduction, minimization of driving force, driving precision, etc.

A first magnet M1 and a second magnet M2 that face the first coil C1 and the second coil C2, respectively, are installed on the second carrier 200, which is a moving body. The first magnet M1 and the second magnet M2 are provided on the second carrier 200 as shown in FIGS. 1 and 2, and are provided in directions orthogonal to each other.

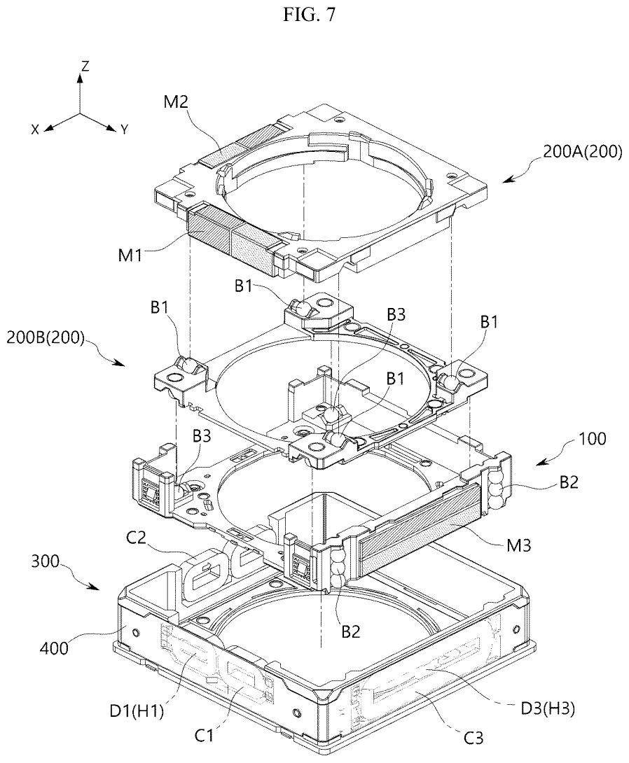

The first and second magnets M1 and M2 correspond to the OIS magnets for OIS driving, and the first and second coils C1 and C2 correspond to the coils for OIS driving. If power of appropriate magnitude and direction is applied to the first coil C1, a magnetic force (electromagnetic force) is generated in the first magnet M1 installed on the second carrier 200, and the second carrier 200 moves in the first direction (X-axis direction) with respect to the first carrier 100 using the generated magnetic force as a driving force. Depending on an embodiment, a detection sensor such as the first hall sensor H1 may be further included. In this case, if the first hall sensor H1 detects the position of the first magnet M1 of the second carrier 200 using the Hall effect or the like and transmits a corresponding signal to the operation drive D1 (see FIG. 7), the operation drive D1 controls power of a corresponding magnitude and direction to be cyclically applied to the first coil C1.

The operation drive may be implemented as an independent electronic component, element, etc., but may also be implemented as a single electronic component (chip) integrated with the first hall sensor H1 through SOC (System On Chip) or the like.

From a corresponding viewpoint, if power of an appropriate magnitude and direction is applied to the second coil C2, a magnetic force (electromagnetic force) is generated in the second magnet M2 of the second carrier 200, and the second carrier 200 moves in the second direction (Y-axis direction) with respect to the first carrier 100 using the generated magnetic force as a driving force. The contents of the second hall sensor H2, etc. correspond to the contents of the first hall sensor H1 explained above, so they are not described again. The first and second hall sensors H1 and H2 correspond to hall sensors for OIS driving.

The first coil C1, the first hall sensor H1, the second coil C2, the second hall sensor H2, etc. may be provided in the housing 300 in the form mounted on the circuit board 400. The AF coil C3 and the third hall sensor H3, explained later, are also the same.

Meanwhile, at one side of the first carrier 100, an AF magnet M3 is provided to face the AF coil C3 provided in the housing 300, and an AF ball B2 is disposed between the second groove rail 310 formed on the inner side of the housing 300 and the second guide rail 120 formed on the outer side of the first carrier 100.

As described above, if power of an appropriate magnitude and direction is applied to the AF coil C3, an electromagnetic force is generated between the AF coil C3 and the AF magnet M3, and the first carrier 100 moves linearly in the optical axis direction (Z-axis direction) with respect to the housing 300 due to the generated electromagnetic force. Therefore, regarding the AF driving, the first carrier 100 becomes a relative moving body, and from a corresponding viewpoint, the housing 300 becomes a relative fixed body.

If the first carrier 100 moves in the optical axis direction, the second carrier 200 accommodated in the first carrier 100 also moves in the optical axis together with the first carrier 100, causing the lens (not shown) mounted on the second carrier 200 to move linearly in the optical axis direction.

If the first carrier 100 moves in the optical axis direction in this way, the distance between the lens and the image sensor (not shown), such as a CCD (Charged-coupled Device) or CMOS (Complementary Metal-oxide Semiconductor) equipped at the rear end of the actuator 1000, is adjusted, thereby implementing an auto-focus function or a zoom function.

Feedback loop control using the third hall sensor H3, etc., as described above, may also be applied in the implementation of the AF function.

As described above, the first carrier 100 of the present disclosure functions as a relative moving body in AF driving and as a relative fixed body in OIS driving.

According to an embodiment, the housing 300 of the present disclosure may include a yoke plate 500 that generates an attractive force with the AF magnet M3.

Due to the attractive force between the yoke plate 500 and the AF magnet M3, the first carrier 100 mediated by the AF ball B2 is pulled toward the housing 300, so that contact between the AF ball B2 and the first carrier 100 and between the AF ball B2 and the housing 300 may be continuously maintained.

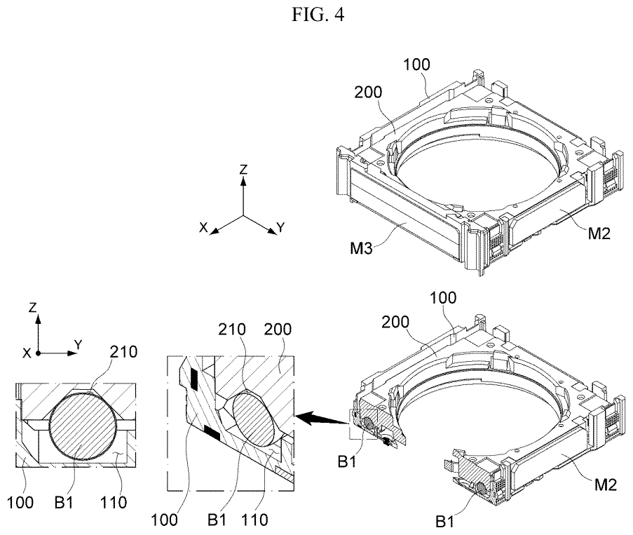

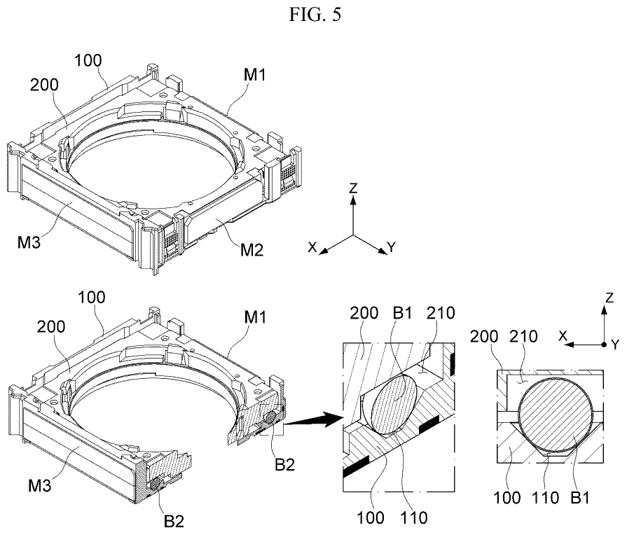

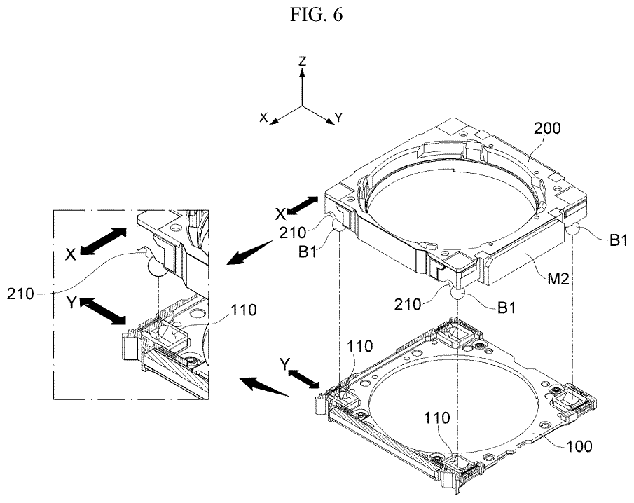

FIGS. 2 and 3 are drawings showing detailed configurations of the first carrier 100 and the second carrier 200 according to a preferred embodiment of the present disclosure, FIGS. 4 and 5 are drawings showing the structures of the first ball B1, the groove rail 110, and the guide rail 210, and FIG. 6 is a drawing for explaining the physical structure in which the second carrier 200 moves in each direction with respect to the first carrier 100. A guide rail 210 is formed on the second carrier 200 of the present disclosure, and the first ball B1 is disposed such that a part of the first ball B1 is accommodated in the guide rail 210.

As shown in FIG. 2, the guide rail 210 has a shape in which a groove extends in the longitudinal direction. As an embodiment thereof, FIG. 2 shows a guide rail 210 having a rail structure extending in the X-axis direction (first direction).

Therefore, the first ball B1 accommodated in the guide rail 210 may move freely in a specific direction, but its movement is restricted in a direction orthogonal to the direction in which free movement is allowed.

When looking at this from the relative perspective of the second carrier 200, the second carrier 200 may move freely in the first direction (X-axis direction) by means of the first ball B1, but its movement is restricted in the second direction (Y-axis direction).

In other words, if the second carrier 200 moves in the first direction, the second carrier 200 moves independently of the first ball B1 while maintaining the contact with the first ball B1, whereas if the second carrier 200 moves in the second direction, free movement is restricted between the second carrier 200 and the first ball B1, so the second carrier 200 moves together with the first ball B1.

In order to more clearly implement such behavioral characteristics, it is desirable that the groove of the guide rail 210 is configured to have a vertical cross section in a V shape.

If the rail is configured in a V shape in this way, contact with the first ball B1 is made on the diagonal surface, so movement in the second direction (Y-axis direction) is more effectively restricted, and linearity (straightness) for free movement in the first direction may be further improved.

Meanwhile, the groove rail 110 formed on the first carrier 100 also has a shape in which the groove extends in the longitudinal direction, as shown in FIG. 3, but extends in a direction orthogonal to the extension direction of the guide rail 210. As an embodiment thereof, FIG. 3 shows a groove rail 110 having a rail structure extending in the Y-axis direction (second direction).

The first ball B1 may move freely in the Y-axis direction (second direction) with respect to the groove rail 110, but its movement is restricted in the first direction (X-axis direction), contrary to the guide rail 210 described above.

Therefore, with respect to the first ball B1 located between the guide rail 210 and the groove rail 110, the guide rail 210 and the groove rail 110 are formed such that the extension directions of the upper and lower rails perpendicularly cross each other.

That is, as shown in FIG. 4, based on YZ plane, the guide rail 210 having a cross-section in a V shape (specifically, an upside-down V shape) comes into contact with the first ball B1 at the upper portion of the first ball B1, and the groove rail 110 having a space extending in the longitudinal direction is positioned at the lower portion of the first ball B1. In addition, as shown in FIG. 5, based on the XZ plane, the groove rail 110 having a V-shaped cross-section comes into contact with the first ball B1 at the lower portion of the first ball B1, and the guide rail 210 having a space extending in the longitudinal direction is positioned at the upper portion of the first ball B1.

In this structure, if a driving force in the first direction (X-axis direction) component is generated by the magnetic force between the first magnet M1 and the first coil C1, the movement of the first ball B1 is restricted by the groove rail 110 located therebelow, and in this state, the second carrier 200 moves in the first direction by the guiding of the first ball B1 and the guide rail 210 having a shape extending in the first direction. As explained above, in this case, the first ball B1 does not move together with the first carrier 100.

From a corresponding viewpoint, if a driving force of the second direction (Y-axis direction) component is generated between the second magnet M2 and the second coil C2, the second carrier 200 moves along the groove rail 110 having a shape extending in the second direction together with the first ball B1, whose movement is restricted by the guide rail 210.

If the guide rail 210 and the groove rail 110 facing each other are configured to perpendicularly cross each other in this way, independent movement in the first direction and the second direction, which are perpendicular to each other, may be achieved, and the straightness or linearity of the movement in each direction may also be effectively implemented.

In the embodiment shown in the drawings, all of the guide rails 210 are illustrated as rails having a shape extending in the first direction (X-axis direction) and all of the groove rails 110 are illustrated as rails having a shape extending in the second direction (Y-axis direction). However, this is only one embodiment, and if the extended shapes of the guide rails 210 and the groove rails 110 facing each other may perpendicularly cross each other, some of the guide rails 210 may also be implemented as rails having a shape extending in the first direction and the other of the guide rails 210 may also be implemented as rails having a shape extending the second direction.

In addition, although the embodiment shown in the drawings shows four pairs of guide rails 210 and groove rails 110 facing each other, this is only one embodiment, and independent movement in each direction may be implemented even if two or more pairs of guide rails 210 and groove rails 110 facing each other are provided regardless of their positions.

Therefore, the groove rail 110 formed on the first carrier 100 may be provided in a number of m (m is a natural number greater than or equal to 2), the guide rail 210 formed on the second carrier 200 may be provided in a number of n (n is a natural number greater than or equal to 2), and two or more of the m groove rails 110 may be configured to face (be perpendicular and cross) two or more of the n guide rails.

It may be desirable that n and m are the same number, but even if they are not the same number, the technical idea of the present disclosure may be implemented as long as at least two pairs of groove rails 110 and guide rails 210 facing each other (be perpendicular and cross) are provided as described above.

In addition, if the number is not the same, the side facing the surplus component among the groove rails 110 and the guide rails 210 may be formed in a planar shape to allow free movement of the first ball B1.

Depending on an embodiment, the side facing the surplus component may be configured in a pocket shape to allow free movement of the first ball B1 in a certain area, but prevent the first ball B1 from escaping outside the area.

It is more desirable that both of the groove rail 110 and guide rail 210 facing each other (be perpendicular and cross) are implemented as V-shaped rails. This configuration not only effectively restricts the first ball B1 from deviating or moving in an unintended direction, but also guides the first ball B1 to linearly move precisely in the intended specific direction.

It is preferable that a magnetic body made of a magnetic material to generate an attractive force with the first magnet M1 and the second magnet M2 provided on the second carrier 200 is provided on the first carrier 100 so that contact may be effectively maintained between the second carrier 200 and the first ball B1 and between the first ball B1 and the first carrier 100 and so that the second carrier 200 may be restored to a reference position when the OIS driving in each direction is terminated.

FIG. 7 is a drawing showing another embodiment of the OIS carrier (second carrier) 200.

The OIS carrier 200 of the present disclosure may be implemented in a form including a lens carrier 200A on which a lens is mounted, and a middle guide 200B, as shown in FIG. 7.

In this embodiment, the first ball B1 may be disposed between the lens carrier 200A and the middle guide 200B, and the second ball B3 may be disposed between the middle guide 200B and the AF carrier (first carrier) 100.

With this structure, when a driving force is generated between the first magnet M1, which is an OIS magnet, and the first coil C1, which is an OIS coil, the lens carrier 200A moves in the first direction (X-axis direction) through the guiding of the second ball B3 together with the middle guide 200B with the AF carrier 100 as a relative fixed body.

Also, when a driving force is generated between the second magnet M2, which is an OIS magnet, and the second coil C2, which is an OIS coil, the lens carrier 200A moves in the second direction (Y-axis direction) through the physical guiding of the first ball B1 with the middle guide 200B as a relative fixed body.

Other components shown in FIG. 7 are identical or corresponding to those described in FIG. 1 to 6, and thus will not be described again.

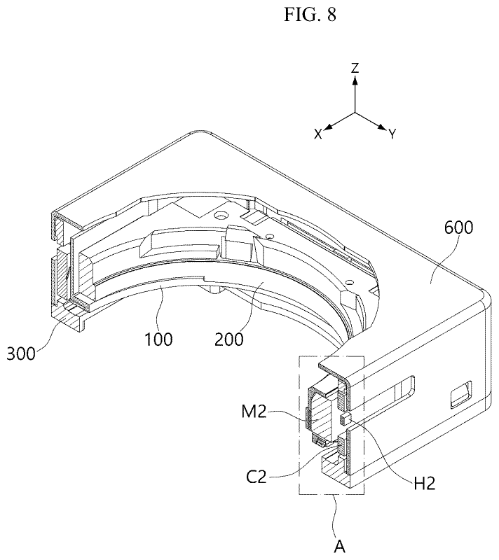

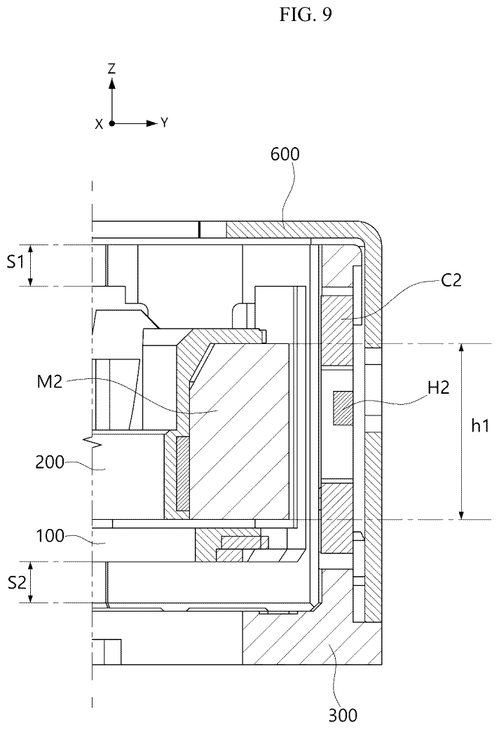

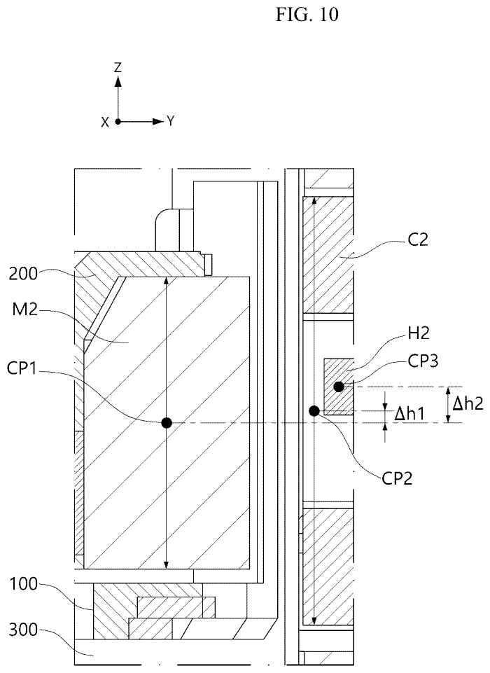

FIG. 8 is a drawing showing the internal structure of the actuator 1000 according to an embodiment of the present disclosure, FIG. 9 is a drawing for explaining a part A of FIG. 8 in detail, and FIG. 10 is a drawing for explaining the mutual positional relationship of a second magnet M2, which is one of the OIS magnets M1 and M2, a second coil C2, which is one of the OIS coils C1 and C2, and a second hall sensor H2, which is one of the OIS hall sensors.

As described above, the OIS carrier 200 of the present disclosure is a moving body that moves in a direction (X-axis direction or/and Y-axis direction) perpendicular to the optical axis direction (Z-axis direction), and the AF carrier 100 of the present disclosure corresponds to a relative fixed body that supports the movement of the OIS carrier 200.

The AF carrier 100 of the present disclosure moves forward and backward in the optical axis direction (Z-axis direction) with the housing 300 as a relative fixed body when the AF is driven. Since the OIS carrier 200 is supported by the AF carrier 100, when the AF carrier 100 moves in the optical axis direction, the OIS carrier 200 also moves in the optical axis direction together with the AF carrier 100.

If the OIS carrier moves up and down based on the optical axis direction by AF driving, the positional relationship between the OIS magnets M1, M2 and the OIS coils C1, C2 and the positional relationship between the OIS magnets M1, M2 and the OIS hall sensors H1, H2 for OIS driving are described.

Since the OIS magnets M1 and M2 are installed in the OIS carrier 200, if the OIS carrier 200 moves in the optical axis direction together with the AF carrier 100 by AF driving, the OIS magnets M1 and M2 also move in the optical axis direction.

If the AF is driven, the positions of the OIS magnets M1 and M2 change based on the optical axis direction. However, since the OIS coils C1 and C2, which provide a driving force to the OIS magnets M1 and M2, and the OIS hall sensors H1 and H2, which detect the magnetic force of the OIS magnets M1 and M2, are installed in the housing 300, their positions do not change by AF driving.

Therefore, if the AF is driven, the positional relationship between the OIS magnets M1, M2 and the OIS coils C1, C2 and the positional relationship between the OIS magnets M1, M2 and the OIS hall sensors H1, H2 dynamically change depending on whether AF is driven and the degree of movement due to AF.

Position sensing for OIS is generally designed based on the positional relationship between the OIS magnets M1, M2 and the OIS hall sensors H1, H2, and the provision of a driving force for OIS is generally designed based on the positional relationship between the OIS magnets M1, M2 and the OIS coils C1, C2.

However, if the positional relationship between these components (the OIS magnet and the OIS coil, the OIS magnet and the OIS hall sensor) changes depending on the driving of the AF, it becomes difficult to precisely implement position sensing for OIS as well as providing a driving force for OIS.

In particular, when the moving distance (stroke) of the AF carrier 100 by AF driving becomes longer due to high specifications of the lens, etc., the range of positional deviation between them becomes larger, so the precision of position sensing for OIS and provision of OIS driving force may further deteriorate.

To solve these problems, a method of improving the algorithm for drive control may be applied, but as discussed above, such a method may have a negative effect on response characteristics because it increases the computational processing time.

In order to structurally solve this problem, it is desirable that the height (based on the optical axis direction) (h1, see FIG. 9) of the OIS magnets M1 and M2 according to the present disclosure is configured to be more than twice the stroke (S1+S2), which is the moving distance of the AF carrier 100 by AF driving.

If the height (based on the Z-axis direction) of the OIS magnets M1 and M2 is more than twice the stroke in this way, even if the positions (optical axis direction) of the OIS magnets M1 and M2 change due to AF driving, the positional relationship facing the OIS coils C1 and C2 may be maintained, thereby increasing the efficiency of providing a driving force.

The upper limit of the height of the OIS magnet M1, M2 may be determined by considering the height of the actuator 1000 itself or the position and structure of a stopper, etc. provided inside the actuator 1000.

The height (optical axis direction/Z-axis direction) of the OIS coil C1, C2 may be designed to correspond to the height of the OIS magnet M1, M2.

FIG. 9 shows the AF carrier 100 positioned at the center position of the stroke, and related components. As described above, the AF carrier 100 being positioned at the center position of the stroke means that the OIS magnets M1 and M2 are also positioned at corresponding positions.

Based on FIG. 9, the stroke, which is a moving distance of the AF carrier 100 moving in the optical axis direction by AF driving, is the sum of S1 and S2.

If the AF carrier 100 rises upward along the optical axis direction, the size of S1 decreases and the size of S2 increases. The opposite happens if the AF carrier 100 descends downward along the optical axis direction. Even if the position of the AF carrier 100 in the optical axis direction changes, the stroke size remains constant.

The OIS may be a function that prevents image degradation caused by hand trembling, etc. by moving the lens in an opposite direction when phenomena such as hand trembling occur. In a close-up or close-distance photographing environment, hand trembling, etc. are reflected relatively more significantly due to the optical relationship between a subject, a lens, and an image sensor.

Therefore, it is desirable to design the OIS hall sensor H1, H2 to have relatively high resolution and precision in conditions such as close-up photography, and from a corresponding perspective, it is desirable to design the OIS driving force to be provided more precisely in conditions such as close-up photography.

Close-up photography means that the lens and the subject is close to each other, which means the case where the AF carrier 100 is raised in the optical axis direction by AF driving, etc., namely the case where the OIS carrier 200 on the OIS magnets M1 and M2 are installed is raised in the optical axis direction.

The alignment of the positions between the OIS magnets M1, M2 and the OIS hall sensors H1, H2 becomes better, the resolution and precision are enhanced. The alignment of the positions between the OIS magnets M1, M2 and the OIS coils C1, C2 becomes better, the driving performance and precision are improved.

Therefore, as illustrated in FIGS. 9 and 10, based on the case where the AF carrier 100 is positioned at the center position of the stroke, it is preferable that the center position CP1 of the OIS magnets M1 and M2 by the present disclosure is equal to or lower than the center position CP2 of the OIS coils C1 and C2 and the center position CP3 of the OIS hall sensors H1 and H2.

Here, the center position means a center position based on the height (optical axis direction) of the corresponding configuration.

In this way, based on the case where the AF carrier 100 is positioned at the center position of the stroke, if the center position CP1 of the OIS magnets M1 and M2 is lower than the center position CP3 of the OIS hall sensors H1 and H2 (Δh2) and the center position CP1 of the OIS magnets M1 and M2 is lower than the center position CP2 of the OIS coils C1 and C2 (Δh1), when the AF carrier 100 is raised in a close-up photographing environment (based on the optical axis direction), the position alignment rate of the center positions of the OIS magnets M1 and M2 and the center positions of the OIS hall sensors H1 and H2 and the position alignment rate of the center positions of the OIS magnets M1 and M2 and the center positions of the OIS coils C1 and C2 are increased.

In this configuration, in a condition where position detection and driving precision are more highly required, namely in a close-up photographing condition where the AF carrier 100 and OIS carrier 200 are raised by AF driving, the position alignment rate between the OIS magnets M1, M2 and the OIS hall sensors H1, H2 and between the OIS magnets M1, M2 and the OIS coils C1, C2 increases, so the precision of position detection and driving may be improved.

It is desirable that the height deviation (Δh1) between the center position CP1 of the OIS magnet M1, M2 and the center position CP2 of the OIS coil C1, C2 and the height deviation (Δh2) between the center position CP1 of the OIS magnet M1, M2 and the center position CP3 of the OIS hall sensor H1, H2 is 30% or less of the stroke, based on the case where the AF carrier 100 is located at the center position of the stroke.

If the center position CP1 of the OIS magnets M1 and M2 is too low based on the case where the AF carrier 100 is located at the center position of the stroke, it may make the structural design of the actuator 1000 difficult. Also, if the OIS magnets M1 and M2 move in the negative direction (−Z-axis direction) based on the center position of the stroke due to AF, it may be difficult to maintain the normal operation of the OIS (such as position detection and driving force provision), and further problems such as a decrease in driving force due to a reduction in the size of the OIS magnets M1 and M2 may occur.

Preferably, the center position CP3 of the OIS hall sensor H1, H2 of the present disclosure may be configured to be higher than the center position of the OIS coil C1, C2 based on the case where the AF carrier 100 is positioned at the center position of the stroke, as illustrated in FIG. 10.

The hall sensor detects the magnitude and direction of the magnetic field of the magnet within the detection area using the hall effect. Through experiments and simulations in various environments and conditions, the linearity between the position of the magnet (based on the driving direction of the OIS, for example, the X-axis or Y-axis direction) and the output value of the hall sensor is improved to be optimized when the center position CP3 of the OIS hall sensors H1 and H2 is slightly higher than the center position CP1 of the OIS magnets M1 and M2 (optical axis direction).

Therefore, if the center position of the OIS hall sensors H1 and H2 is configured to be higher than the center position of the OIS coils C1 and C2, higher OIS performance may be achieved under close-up photographing conditions.

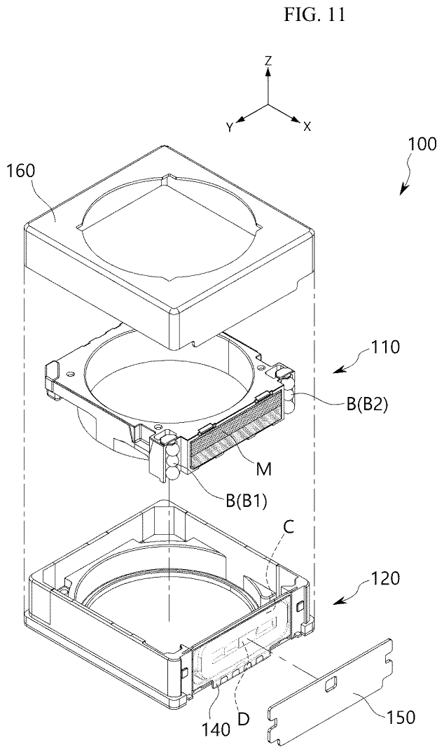

Hereinafter, the actuator 100 according to the second embodiment of the present disclosure will be described in detail with reference to FIGS. 11 to 15, etc.

Some of the terms and/or reference signs referring to the actuator and components included therein according to the second embodiment described below may be different from the terms and/or reference signs mentioned in the former embodiment.

This is due to the instrumental necessity of distinguishing embodiments and effectively explaining the corresponding embodiments. Thus, if the corresponding technical ideas can be implemented by those skilled in the art technician, it should be interpreted that the configurations of the embodiments described below may be the same as or equivalent to the configurations described above.

For example, the carrier 110 described in the second embodiment below corresponds to a configuration corresponding to the AF carrier 100 (first carrier) described in the former embodiment, and the housing 120, the yoke plate 150, the circuit board 140, and the case 160 of the second embodiment correspond to the housing 300, the yoke plate 500, the circuit board 400, and the case 600 of the former embodiment, respectively.

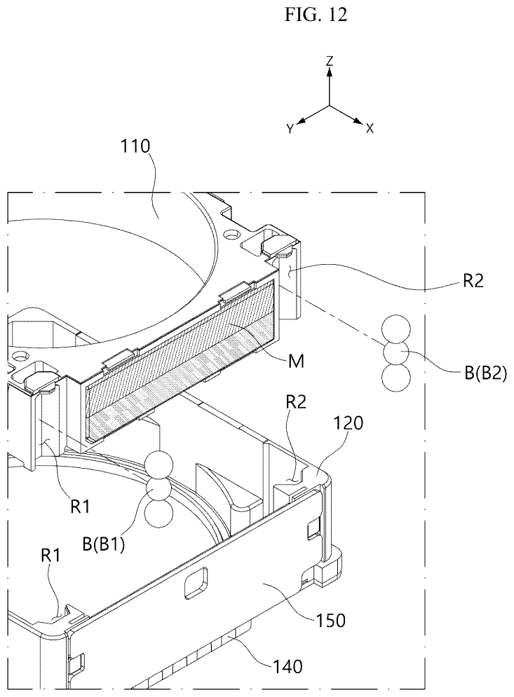

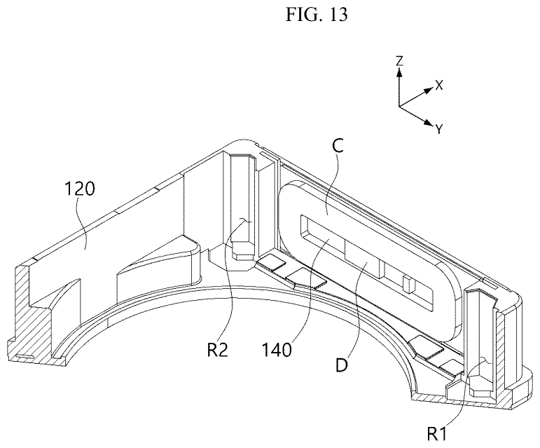

FIG. 11 is a drawing showing the configuration of an actuator 100 for a camera (hereinafter, referred to as “actuator”) according to a preferred second embodiment of the present disclosure, and FIGS. 12 and 13 are drawings for explaining the ball B, the first rail R1, the second rail R2, etc. shown in FIG. 11.

Hereinafter, the general configuration of the actuator 100 of the present disclosure is described in detail, and the specific details of the present disclosure, such as the structural relationship between the ball B, the yoke plate 150, the magnet M, and the stroke H3, are described later.

As shown in FIG. 11, the actuator 100 according to the second embodiment of the present disclosure may be configured to include a carrier 110, a housing 120, a circuit board 140, a magnet M, and a coil C, and may include a case 160 that functions as a shield can depending on an embodiment.

The actuator 100 according to the present disclosure corresponds to a device that implements AF or zoom function by linearly moving the carrier 110 forward or backward using the electromagnetic force (magnetic force) between the coil C and the magnet M as a driving force.

Although the drawing shows an embodiment in which AF is implemented alone, the actuator 100 of the present disclosure may be implemented not only in an actuator in which AF and OIS functions are applied in an integrated manner, as in the embodiment described above, but also in an actuator in which a reflector is applied.

The carrier 110 of the present disclosure may be located in the inner space provided by the housing 120 and corresponds to a moving body that moves in the optical axis direction with respect to the housing 120. From a corresponding perspective, the housing 120, which supports the linear movement of the carrier 110, corresponds to a relative fixed body.

According to an embodiment, one or more lenses or lens assemblies (hereinafter, referred to as “lenses”) may be mounted on the carrier 110. If the lens is mounted on the carrier 110 in this manner, the lens moves linearly by the movement of the carrier 110, and the relative distance between the lens and the image sensor is adjusted by the movement of the lens, thereby implementing an AF or zoom function.

The driving unit that linearly moves the carrier 120 in the optical axis direction is configured to move the carrier 110 in a specific direction using an external control signal or a detected signal system, and may be implemented by various means such as a shape memory alloy (SMA), a piezoelectric element, or a micro electro mechanical system (MEMS).

However, considering the efficiency of device miniaturization, power consumption, noise suppression, space utilization, linear movement characteristics, precision control, etc., it is desirable that the driving unit is implemented to use the electromagnetic force (magnetic force) generated between the magnet and the coil as illustrated in the drawings. In this regard, the coil may be installed in the moving body and the magnet may be installed in the fixed body, but in order to increase the efficiency of electrical connection, structural design, etc., it is preferable that the magnet M is installed on the carrier 110, which is a moving body, and the coil C is installed in the housing 120, which is a relative fixed body, as illustrated in the drawings.

Depending on an embodiment, a hall sensor for detecting the position of the magnet M1 or a sensing magnet, and an operation drive D for controlling the magnitude and direction of the current supplied to the coil C using a signal output by the hall sensor may be included. Since the hall sensor is typically implemented in the form of a single electronic component (chip) integrated with the operation drive D, it is not shown separately in the drawings.

The coil C, the operation drive D, etc. may be mounted on the circuit board 140, and it is preferable that the circuit board 140 is configured to be partially exposed to the outside for interfacing with an external module, a power supply, an external device, etc.

A plurality of balls B are arranged between the carrier 110 and the housing 120. Specifically, the plurality of balls B may be a first ball group B1 arranged on the first rail R1 formed on at least one of the carrier 110 and the housing 120, or/and a second ball group B2 arranged on the second rail R2 formed on at least one of the carrier 110 and the housing 120, but formed in parallel with the first rail R1.

In order to effectively guide the linear movement of the carrier 110, it is desirable that the balls belonging to the first ball group B1 are configured to be partially accommodated in the first rail R1. The balls corresponding to the second ball group B2 are also configured in the same manner. The first ball group and the first balls belonging to the first ball group are designated by the same reference symbol B1 as long as they do not need to be distinguished separately.

The drawings show that both the first and second ball groups B1, B2 include a plurality of balls arranged in the optical axis direction, but one of the first and second ball groups B1, B2 may include a single ball.

Although the drawings show an embodiment in which both the carrier 110 and the housing 120 include the first rail R1, depending on an embodiment, the first rail may be provided only to one of them. In this case, the component without a first rail may have a groove or a pocket for accommodating one or more balls (first balls) belonging to the first ball group B1 and preventing the first ball B1 from being deviated externally. The same applies to the second rail R2.

If the first ball B1, B2 is interposed between the carrier 110 and the housing 120 in this way, the carrier may linearly move more flexibly due to minimized friction caused by rolling, moving, rotation, point contact of the ball with a facing object, etc., and it may have the advantages of noise reduction, minimization of driving force, and improved driving precision.

Regarding the rails R1 and R2 on which the balls B1 and B2 are arranged, one of the first rail R1 and the second rail R2 may be configured such that its cross-section (horizontal cross-section based on the optical axis direction) has a “V” shape, and the other may be configured such that its cross-section has a “U” shape.

If the cross sections of the first rail R1 and the second rail R2 are configured to have different geometrical characteristics in this way, the contact areas with the balls B1 and B2 and the rotational characteristics may be configured differently, thereby improving the driving characteristics such as the linearity of movement and driving efficiency of the carrier 110 moving in the optical axis direction.

If the second rail R2 having a “V-shaped” cross-section is provided in both the carrier 110 and the housing 120, the second rails R2 are arranged so that their open parts face each other, and one or more balls (second balls) belonging to the second ball group B2 are arranged therebetween. Therefore, the second ball B2 comes into contact with both the second rail R2 of the carrier 110 and the second rail R2 of the housing 120 while being partially accommodated in the second rail R2.

The carrier 110 linearly moves precisely through the physical support of the second ball group B2 and the guiding of the second rail R2 by this physical structure.

Here, the cross-section being formed in a ‘V shape’ means that not only it is in the shape of the alphabet V, but it is also formed in a shape where the second ball B2 faces the inner surface of the second rail R2 at two points.

If the first rail R1 provided in the housing 120 has a U-shaped cross-section, it may be desirable for the linear movement of the carrier 110 that the first rail R1 provided in the carrier 110 facing the rail R1 has a V-shaped cross-section.

The fact that the cross-section is in a ‘U shape’ means that not only the cross-section is in the shape of the alphabet U, but it is also formed in a shape having a certain amount of free space at the inner side of the ball and the rail, including a trapezoidal shape. As an example, the drawings show an embodiment in which both the first and second rails R1 and R2 provided on the carrier 110 have a V-shaped cross-section, and one of the first rail R1 and second rail R2 provided in the housing 120 has a V-shaped cross-section and the other has a U-shaped cross-section.

The housing 120 of the present disclosure is equipped with a magnet M provided in the carrier 110 and a yoke plate 150 made of a magnetic material that generates an attractive force.

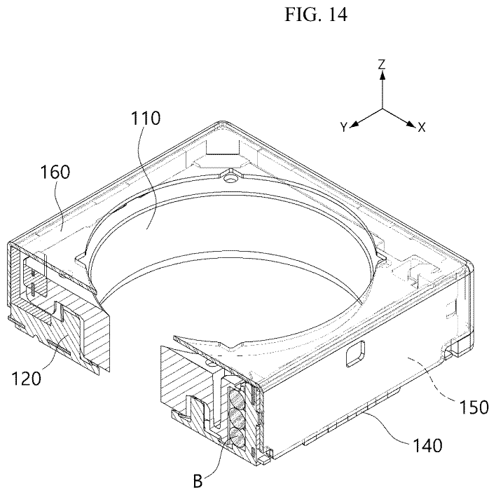

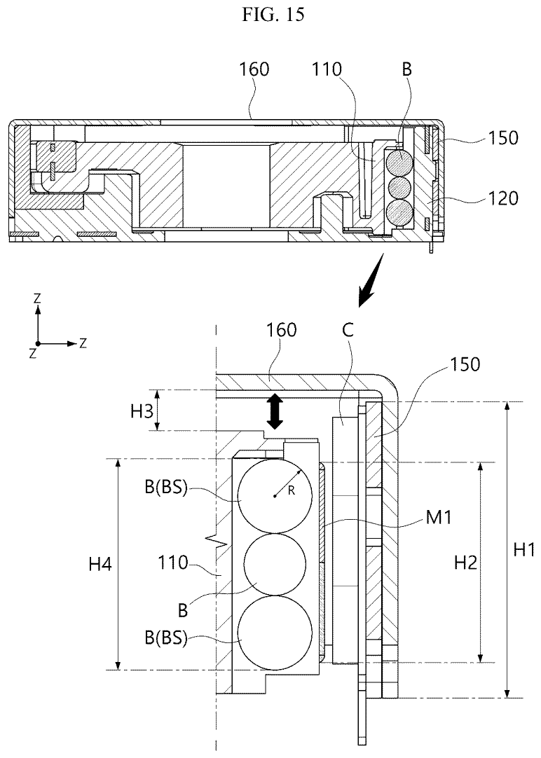

The housing 120 of the present disclosure includes a yoke plate 150 made of a magnetic material to generate an attractive force with the magnet M provided on the carrier 110 If an attractive force or suction force is generated between the magnet M and the yoke plate 150, in a state where the balls B1 and B2 are placed between the carrier 110 and the housing 120, the carrier 110 is brought into close contact with the housing 120 (X-axis direction based on the drawing), so that physical contact may continue between the balls B1 and B2 and the carrier 110, as well as between the balls B1 and B2 and the housing 120. FIG. 14 is a partial cross-sectional view showing the ball B and the yoke plate 150, and FIG. 15 is a drawing for explaining the structural relationship between the yoke plate 150, the ball B, the magnet M, and the stroke H3.

As mentioned above, the yoke plate 150 of the present disclosure is configured to be installed on the housing 120, which is a relative fixed body, and generates an attractive force with the magnet M installed on the carrier 110, which is a moving body.

Since the magnet M is a permanent magnet and the yoke plate 150 is made of magnetic material, the attractive force between them is constant regardless of the movement of the carrier 110.

Since the ball B is placed between the carrier 110 and the housing 120, even if the magnet M installed on the carrier 110 moves forward and backward in the optical axis direction due to AF driving, the contact force between the housing 120 and the ball B and between the ball B and the carrier 110 must be maintained so that linear movement of the carrier 110 due to AF driving may be continuously performed without gap or tilt.

Therefore, it is desirable that the height H1 of the yoke plate 150 is designed to be greater than the height H2 of the magnet M, and it is also desirable that the height H1 is designed to be greater than the sum (H2+H3) of the height H2 of the magnet M and the stroke H3, which is the range or length area in which the carrier 110 moves in the optical axis direction.

The plurality of balls B placed between the housing 120 and the carrier 110 are configured to not only physically support the carrier 110, but also directly guide the physical movement of the carrier 110. As discussed above, the balls B may move with a degree of freedom in the optical axis direction, but do not have the same movement characteristics, such as the movement direction and movement distance, as the carrier 110.

Therefore, the carrier 110 does not have a posture problem such as tilting, only when the physical support or guiding of the ball B for the carrier 110 is maintained and the physical contact point (position of point contact) between the ball B and the carrier 110 does not go beyond the suction area by the magnet M and the yoke plate 150.

Therefore, it is desirable that the sum (H4+H3) (hereinafter, referred to as ‘first distance’) of the height (stack height) (H4) of all of the plurality of balls B and the stroke H3 is smaller than the sum (R+H1) of the radius of one ball (hereinafter, referred to as ‘contrast ball’) among the plurality of balls B and the height of the yoke plate 150.

If all of the plurality of balls B have the same diameter, the contrast ball may be any one of the plurality of balls.

If the end of the carrier 110 (based on the optical axis direction) deviates from the center of the ball B located at the outermost side (based on the optical axis) among the plurality of balls B, the equilibrium support of the carrier 110 may be broken. Therefore, if the sizes of the plurality of balls B are not all the same, it is preferable that the contrast ball is the ball BS located at the outermost side among the plurality of balls B.

Since the diameters of the plurality of balls B cannot be perfectly matched to each other and the movement and stop of the carrier 110 occur randomly during AF driving, when the carrier 110 moves in the optical axis direction, the ball B that actually contacts the carrier 110 may change from time to time.

Therefore, if the diameter of the ball BS (hereinafter, referred to as the ‘main ball’) arranged at the outermost side among the plurality of balls B arranged in the optical axis direction is configured to be larger than the diameters of the other balls B, the carrier 110 may be induced to always contact the main ball BS. Furthermore, since the main ball BS with a relatively large diameter is arranged at the outermost side among the plurality of balls, the possibility of the carrier 110 being tilted may be relatively reduced.

The attached drawings show that the first ball group B1 and the second ball group B2 include the same number of balls, but depending on an embodiment, the first ball group B1 and the second ball group B2 may include different numbers of balls, and as mentioned above, one of these ball groups may include a single ball.

If a plurality of ball groups are arranged side by side between the housing 120 and the carrier 110 in this case, it is preferable that the ‘height of all of the plurality of balls B (H4)’, which is a component of the first distance (H4+H3), is determined as the overall height of the ball group (hereinafter, referred to as the 'support ball group') with a relatively large overall height among the plurality of ball groups.

In this case, it is desirable that the first distance (H4+H3), namely the sum of the height (H4) and the stroke H3 of the support ball group, is smaller than the sum (R+H1) of the radius (R) of the ball located at the outermost side among the balls belonging to the support ball group and the height H1 of the yoke plate 150.

If power of an appropriate magnitude and direction is applied to the coil C through the control of the operation drive D, a magnetic force (electromagnetic force) is generated between the coil C and the magnet M. As shown in the drawings, the coil C, which generates a driving force, is preferably designed to have a height area that may cover the moving range (stroke) of the magnet M installed on the carrier 110.

Since the magnet M has weight and is installed on the carrier 110, which is a moving body, leaving aside the fact that it may act as a load during operation, since the object on which the driving force by the coil C directly acts is the magnet M, as the size (height based on the optical axis direction) of the magnet M is larger, the driving force may also be increased.

However, since the magnet M is a target to which the driving force is directly applied, if the driving force is applied to an area beyond the physical support provided by the ball B, poor posture of the carrier 110 may relatively easily occur.

Therefore, it is desirable that the height of the magnet M (based on the optical axis direction) is smaller than the sum (H4+R) of the height (H4) of all of the plurality of balls B and the radius (R) of the ball BS arranged at the outermost side among the plurality of balls. In this case, of course, the height of all of the plurality of balls may be the height of the support ball group.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first” and “second” etc. are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

What is claimed is:

1. An actuator for a camera, comprising:
an optical image stabilization (OIS) carrier configured to move in a direction perpendicular to an optical axis direction;
an autofocusing (AF) carrier configured to support the OIS carrier and move in the optical axis direction together with the OIS carrier;
a housing configured to support the AF carrier;
an OIS magnet installed on the OIS carrier; and
an OIS coil facing the OIS magnet,
wherein a height of the OIS magnet is at least twice a stroke, which is a moving distance of the AF carrier by AF driving.

2. The actuator for a camera according to claim 1, wherein a center position of the OIS magnet is identical to or lower than a center position of the OIS coil, when the AF carrier is located at a center position of the stroke.

3. The actuator for a camera according to claim 2, wherein when the AF carrier is located at the center position of the stroke, a height deviation between the center position of the OIS magnet and the center position of the OIS coil is 30% or less of the stroke.

4. The actuator for a camera according to claim 1, further comprising:
an OIS hall sensor detecting a position of the OIS magnet,
wherein a center position of the OIS magnet is identical to or lower than a center position of the OIS hall sensor, when the AF carrier is located at a center position of the stroke.

5. The actuator for a camera according to claim 4, wherein when the AF carrier is located at the center position of the stroke, a height deviation between the center position of the OIS magnet and the center position of the OIS hall sensor is 30% or less of the stroke.

6. The actuator for a camera according to claim 1, further comprising:
an AF magnet installed on the AF carrier to face an AF coil;
a yoke plate installed in the housing to generate an attractive force with the AF magnet; and
a ball disposed between the housing and the AF carrier,
wherein a height of the yoke plate is greater than the sum of a height of the AF magnet and the stroke.
